(19) United States
(12) Patent Application Publication
(10) Pub. No.: US 2023/0389533 A1
(43) Pub. Date: Dec. 7, 2023

(54) COMPOSITIONS AND METHODS FOR ATTRACTING INSECTS

(71) Applicant: AMERICAN INSECT ATTRACTANTS LLC, Jamestown, RI (US)

(72) Inventors: Sam LIU, Pleasant Hill, CA (US); Raymond W. IANNETTA, Jamestown, RI (US); Miao YONG CAO, Warwick, RI (US)

(21) Appl. No.: 18/249,038

(22) PCT Filed: Oct. 14, 2021
(86) PCT No.: PCT/US2021/055106

§ 371 Date: Apr. 13, 2023

Related U.S. Application Data
(60) Provisional application No. 63/092,052, filed on Oct. 15, 2020.
(60) Provisional application No. 63/154,335, filed on Feb. 26, 2021.

(51) Int. Cl. A01M 1/02; A01N 59/00; A01P 19/00; A01N 59/08; A01N 25/34; A01N 37/36; A01N 31/02

(52) U.S. Cl. CPC A01M 1/023; A01N 59/00; A01P 19/00; A01N 59/08; A01N 25/34; A01N 37/36; A01N 31/02

(57) ABSTRACT

The instant invention provides compositions, systems, and methods of attracting insects. The compositions comprise a carboxylic acid, an alcohol, a metallic base, an optional electrolyte, and an optional drying agent. The method of attracting insects comprises providing an insect catching device comprising a composition capable of releasing one or more gases to attract insects, and utilizing the insect catching device to catch the insects. capable of holding a container.

### CROSS REFERENCE TO RELATED APPLICATIONS

This application claims benefit from U.S. Provisional Patent Application Ser. No. 63/092,052, filed Oct. 15, 2020, and U.S. Provisional Patent Application Ser. No. 63/154,335, filed Feb. 26, 2021, each of which is incorporated herein by reference in their entirety.

### FIELD OF THE INVENTION

The invention relates to novel compositions and methods for attracting and trapping insects using an insect attracting system comprising multiple components including chemical lures.

### BACKGROUND OF THE INVENTION

Mosquitoes belong to an insect group of unfavorable and most harmful as sucking blood from human beings. To exterminate those mosquitoes, various apparatus and devices such as mosquito-repellent incenses, electronic mosquito-repellent devices, electric shock mosquito killers, and others have been used.

Mosquitoes are attracted by the bodily temperature of human beings and other vertebrates and carbon dioxide discharged from respiration. Human or vertebrate release CO₂ during breathing. Mosquitos can find/smell CO₂ from afar and follow trace amounts of CO₂ to bite humans or vertebrates. Many mosquito trapping devices are designed to emit CO₂ to mimic similar discharge from human and other vertebrates.

Propane has been the fuel of choice to generate CO₂. Many mosquito traps have been designed and used to generate heat, carbon dioxide and water vapor to mimic similar discharge by humans. Mosquitoes are also attracted to animals because they are attracted by the odor of octenol like substances produced by animals, for example cattle. Many propane mosquito traps produce and emit odors similar to humans and animals. Lures such as octenol are used to generate animal like odor.

Given the importance of odors emitted by humans or animals in attracting mosquitoes, the use of sensory lures has been tried to trap mosquitoes. Mosquitoes are attracted to chemical signals emitted by the hosts (humans or animals) upon which they feed. Such chemical signals take the form of odor molecules, which drift away from the source by diffusion and by being carried in an air flow.

One chemical attractant is carbon dioxide, which is given off by respiring animals. Carbon dioxide is a ubiquitous gas in the atmosphere, with normal ambient background outdoor levels of 300 to 400 p.p.m. Insects that feed on host organisms are sometimes attracted to the increased carbon dioxide levels that are created by and thus surround the host.

Another chemical attractant detected by the olfactory senses of mosquitoes is an odor molecule such as L-lactic acid. L-lactic acid is a volatile component of human sweat that ranges in concentration from 0.5 to 5.0 mg/l. However, L-lactic acid when presented as a single stimulus, has only a slight or non-attractive effect. But when presented with carbon dioxide, L-lactic acid acts as a synergist and increases the attractiveness of the gas. The use of lactic acid as an attractant is known in the art, for example, U.S. Pat. No. 4,907,366 to Balfour discloses a trap for attracting mosquitoes using a composition consisting of lactic acid, carbon dioxide, water and heat.

Other chemical attractant odor molecules are the group of chemicals known as fatty acids, and, in particular, short-chain fatty acids. Fatty acids are volatile compounds that include, but are not limited to, compounds such as acetic, propionic, isobutyric, butyric, isovaleric and valeric acids, all of which are present in human waste. The use of fatty acids as an attractant is known in the art, for example, U.S. Pat. No. 4,818,526 to Wilson and U.S. Pat. No. 5,258,176 to Keenan relate to attractant composition(s) consisting of propionic acid, n-butyric acid, isobutyric acid, n-valeric acid, isovaleric acid, isocaprionic acid and 2-phenylethanol.

Another such attractant odor molecule is 1-Octen-3-ol (octenol). Octenol is a volatile component of cattle and human breath and sweat. Octenol is a potent olfactory attractant for some mosquito species when combined with increased levels of carbon dioxide. The use of carbon dioxide and/or octenol as an attractant of mosquitoes, biting flies and ticks is known in the art from, for example, U.S. Pat. No. 5,205,064 to Nolen, U.S. Pat. No. 5,382,422 to Dieguez, U.S. Pat. No. 5,799,436 to Nolen, U.S. Pat. No. 6,055,766 to Nolen, U.S. Pat. No. 6,145,243 to Wigton, and U.S. Pat. No. 6,199,316 to Coventry.

Other such attractant odor molecules are carbon disulfide and ketones. U.S. Pat. No. 4,818,526 to Wilson discloses the use of dimethyl disulfide and dibutyle succinate and combinations thereof as attractants for mosquitoes. U.S. Pat. No. 6,267,953 to Bernier et al. discloses the use of lactic acid with dimethyl disulfide and acetone. U.S. Pat. No. 6,800,279 to Bernier et al. discloses the use of lactic acid with carbon disulfide and with butanone, 2-pentanone or acetone.

The combination of highly effective chemical attractants with efficient traps provides an improved control method to be developed. However, as is clear from the diverse prior art, it is not possible to predict which compounds at which dosage levels will be effective attractants of a particular insect species. Accordingly, there is a need for an effective insect attracting system comprising a lure composition for attracting insects such as mosquitoes and the like.

### SUMMARY OF THE INVENTION

Various embodiments of the present invention provide a method of attracting insects. One embodiment provides a method of attracting insects wherein the method comprises providing an insect bait for attracting insects, wherein the insect bait comprises ammonium bicarbonate and a bait-releasing means for enhancing the release of the insect bait, wherein the bait-releasing means atomizes the insect bait to release carbon dioxide to attract insects.

The present invention in one of its aspects provides a composition comprising a carboxylic acid, an alcohol, a mixture of a metallic base and an electrolyte, and an optional drying agent. Another aspect of the instant invention provides a composition comprising a mixture of lactic acid and hexanoic acid, a mixture of a metallic base and an electrolyte, and an optional drying agent. Provided in yet another aspect is an insect attracting system comprising a container with at least three compartments and a breathable cover, wherein a first compartment holds a carboxylic acid, a second compartment holds an alcohol, and a third compartment holds a mixture of a metallic base and an electrolyte. Yet another aspect of the instant invention provides an insect attracting system comprising a container with at least two compartments and a breathable cover and breathable walls, wherein a first compartment holds a carboxylic acid, and a second compartment holds a mixture of a metallic base and an electrolyte.

Another aspect of the instant invention provides an insect attracting system comprising a breathable container with a breathable lid comprising a mixture of a metallic base and an electrolyte. Yet Another aspect of the instant invention provides a method of attracting and trapping insects, wherein the method comprises: (a) providing an insect catching device capable of holding a container; (b) providing a composition comprising a metallic base, and an optional electrolyte; (c) placing the composition in a container having openings within the walls of the container and/or the lid of the container, and placing said container on or inside the insect catching device; (d) facilitating release of one or more gases from the metallic base and the optional electrolyte contained within the container; (e) attracting the insects to the gas released from the metallic base; and (f) utilizing the insect catching device to catch the insects attracted towards the insect catching device.

Another aspect of the instant invention provides a method of attracting and trapping insects, wherein the method comprises: (a) providing an insect catching device capable of holding or accommodating a container; (b) providing a composition comprising a carboxylic acid, an alcohol, a mixture of a metallic base and an electrolyte, and an optional drying agent; (c) placing the composition in a container having openings within the walls of the container and/or the lid of the container, and placing said container on or inside the insect catching device; (d) facilitating release of one or more gases from the metallic base and the optional electrolyte contained within the container; (e) attracting the insects to the gas released from the metallic base; and (f) utilizing the insect catching device to catch the insects attracted towards the insect catching device.

Another aspect of the instant invention provides a method of attracting and trapping insects, wherein the method comprises: (a) providing an insect catching device capable of holding a container; (b) providing a composition comprising a carboxylic acid, an alcohol, a mixture of a metallic base and an electrolyte, and an optional drying agent; (c) placing the composition in a container having openings within the walls of the container and/or the lid of the container, and placing said container on or inside the insect catching device; (d) facilitating release of one or more gases from the metallic base and the optional electrolyte contained within the container; (e) attracting the insects to the gas released from the metallic base; and (f) utilizing the insect catching device to catch the insects attracted towards the insect catching device.

### DETAILED DESCRIPTION OF THE INVENTION

One embodiment provides a method of attracting insects wherein the method comprises providing an insect bait for attracting insects, wherein the insect bait comprises a metallic base, and a bait-releasing means for enhancing the release of the insect bait, wherein the bait-releasing means atomizes the insect bait to release carbon dioxide to attract insects.

A preferred aspect of this embodiment provides a method wherein the metallic base is ammonium bicarbonate, the insect is a mosquito and wherein the method further comprises facilitating evaporation of the mosquito bait using a bait decomposition means. A further preferred embodiment provides a method wherein the mosquito bait further comprises an electrolyte.

Another aspect of this embodiment provides a method wherein the bait comprises up to 10% by weight of the electrolyte. A further preferred embodiment of this aspect provides a method wherein the electrolyte is selected from sodium chloride and sodium bicarbonate.

Another preferred embodiment provides a method wherein the bait-releasing means comprises elevating the temperature of the mosquito bait by using it to facilitate evaporation of the mosquito bait. Yet another preferred embodiment provides a method wherein the bait-releasing means comprises atomizing the mosquito bait through the vibration of a vibration plate, to spread the mosquito bait. Yet another preferred embodiment provides a method wherein the bait-releasing means comprises exposing the mosquito bait by to air or breeze.

Provided in yet another embodiment is a method wherein the bait-releasing means comprises adding a volatile solvent to the mosquito bait, to help spreading the mosquito bait. Another embodiment provides a method wherein the bait-releasing means comprises elevating the temperature of the mosquito bait by using to facilitate evaporation of the mosquito bait.

Another aspect of the invention provides a method wherein the bait-releasing means comprises atomizing the mosquito bait through the vibration of a vibration plate, to help spreading the mosquito bait. Yet another aspect of this method provides a method wherein the bait-releasing means comprises exposing the mosquito bait by to air or breeze. Also provided is a method wherein the bait-releasing means comprises adding a volatile solvent to the mosquito bait, to help spread the mosquito bait.

Compositions according to embodiments of the invention generally will be provided in formulations comprising a carrier containing the attractant compounds. For example, suitable compositions may be suspended in an aqueous solution or in a gel matrix, or may be provided as a solid, as a liquid, or in compressed gas form.

Provided in another aspect of the present invention is a method of attracting mosquitoes wherein the method comprises providing a mosquito bait for attracting mosquitoes, wherein the mosquito bait comprises a mixture of ammonium bicarbonate and an electrolyte, and a bait-releasing means for enhancing the release of the mosquito bait, wherein the bait-releasing means atomizes the mosquito bait to release carbon dioxide to attract mosquitos.

A preferred embodiment provides a method wherein the method further comprises facilitating evaporation of the mosquito bait using a bait decomposition means. Yet another preferred method provides a method wherein the bait comprises up to 10% by weight of the electrolyte. A further preferred method incorporates a bait comprising up to 5% by weight of the electrolyte. Yet another preferred method provides a method wherein the electrolyte is selected from sodium chloride and sodium bicarbonate.

Provided in yet another embodiment is provided a method wherein the bait-releasing means comprises elevating the temperature of the mosquito bait by using to facilitate evaporation of the mosquito bait. Yet another embodiment provides a method wherein the bait-releasing means comprises atomizing the mosquito bait through vibration of a vibration plate, to help spreading the mosquito bait. Another embodiment provides a method wherein the bait-releasing means comprises exposing the mosquito bait by to air or breeze. Another preferred embodiment provides a method wherein the bait-releasing means comprises adding a volatile solvent to the mosquito bait, to help spreading the mosquito bait.

The present invention in one of its aspects provides a composition comprising a carboxylic acid, an alcohol, a mixture of a metallic base and an electrolyte, and an optional drying agent. A preferred embodiment provides a composition wherein: (i) the carboxylic acid is selected from lactic acid, hexanoic acid, and a mixture thereof; and (ii) the alcohol is selected from 1-octen-3-ol, ethanol, and mixtures thereof. Another preferred embodiment provides a composition wherein the carboxylic acid is lactic acid or hexanoic acid, and the alcohol is 1-octen-3-ol. Provided in yet another preferred embodiment is a composition wherein the carboxylic acid is a mixture of lactic acid and hexanoic acid, and the alcohol is 1-octen-3-ol.

Another preferred embodiment provides a composition wherein the metallic base is ammonium bicarbonate and the electrolyte is sodium chloride, with a further preferred composition comprising a mixture wherein the metallic base and electrolyte further comprises a drying agent. A preferred drying agent is selected from magnesium sulfate, silica, and drierite. A further preferred embodiment provides a composition wherein the composition further comprises an absorbent material soaked in the 1-octen-3-ol, and wherein the absorbent material is a piece of cloth or sponge.

Another preferred embodiment provides a composition comprising from about 8% to about 40% by weight of lactic acid; from about 7% to about 20% by weight of 1-octen-3-ol; from about 35% to about 85% by weight of a metallic base; from about 1% to about 5% by weight of an electrolyte; and from about 0% to about 12% by weight of a drying agent.

Yet another preferred embodiment provides a composition from about 8% to about 30% by weight of lactic acid; from about 7% to about 15% by weight of 1-octen-3-ol; from about 45% to about 75% by weight of the metallic base; from about 1% to about 4% by weight of the electrolyte; and from about 0% to about 10% by weight of the drying agent.

A preferred embodiment provides a composition from about 12% to about 15% by weight of lactic acid; from about 12% to about 15% by weight of 1-octen-3-ol; from about 60% to about 65% by weight of the metallic base; from about 1% to about 2% by weight of an electrolyte; and from about 0.8% to about 1.5% by weight of the drying agent.

Another aspect of the instant invention provides a composition comprising a mixture of lactic acid and hexanoic acid, a mixture of a metallic base and an electrolyte, and an optional drying agent. A preferred embodiment of this aspect provides a composition wherein the metallic base is ammonium bicarbonate and the electrolyte is sodium chloride. Yet another preferred embodiment provides a composition wherein the mixture of the metallic base and electrolyte further comprises a drying agent, wherein the drying agent is selected from magnesium sulfate, silica, and drierite. A preferred drying agent is selected from magnesium sulfate, and silica.

Another preferred embodiment provides a composition comprising from about 33% to about 35% by weight of lactic acid; from about 13 to about 15% by weight of hexanoic acid, from about 37% to about 39% by weight of the metallic base; and from about 3% to about 4% by weight of an electrolyte. Yet another preferred embodiment provides a composition comprising from about 20% to about 30% by weight of lactic acid; from about 14 to about 15% by weight of hexanoic acid, from about 38% to about 39% by weight of the metallic base; and from about 3% to about 4% by weight of an electrolyte.

Provided in yet another aspect is an insect attracting system comprising a container with at least three compartments and a breathable cover, wherein a first compartment holds a carboxylic acid, a second compartment holds an alcohol, and a third compartment holds a mixture of a metallic base and an electrolyte. A preferred embodiment of this aspect provides an insect attracting system wherein: (i) the carboxylic acid is selected from lactic acid, hexanoic acid, and a mixture thereof; and (ii) the alcohol is selected from 1-octen-3-ol, ethanol, and mixtures thereof.

A preferred embodiment provides a composition wherein the carboxylic acid is lactic acid, and the alcohol is 1-octen-3-ol. Yet another preferred embodiment provides a composition wherein the carboxylic acid is hexanoic acid, and the alcohol is 1-octen-3-ol. A yet another preferred embodiment provides a composition wherein the carboxylic acid is a mixture of lactic acid and hexanoic acid, and the alcohol is 1-octen-3-ol.

A further preferred embodiment provides a composition wherein the metallic base is ammonium bicarbonate and the electrolyte is sodium chloride. Another further preferred embodiment provides a composition wherein the mixture of the metallic base and electrolyte further comprises a drying agent, and wherein the drying agent is selected from magnesium sulfate, silica, and drierite. A further preferred embodiment provides a composition wherein the composition further comprises an absorbent material soaked in the 1-octen-3-ol, with the preferred absorbent material being a piece of cloth or sponge.

Another preferred embodiment provides a composition comprising from about 8% to about 40% by weight of lactic acid; from about 7% to about 20% by weight of 1-octen-3-ol; from about 35% to about 85% by weight of a metallic base; from about 1% to about 5% by weight of an electrolyte; and from about 0% to about 12% by weight of a drying agent.

Yet another preferred embodiment provides a composition from about 8% to about 30% by weight of lactic acid; from about 7% to about 15% by weight of 1-octen-3-ol; from about 45% to about 75% by weight of the metallic base; from about 1% to about 4% by weight of the electrolyte; and from about 0% to about 10% by weight of the drying agent.

A preferred embodiment provides a composition from about 12% to about 15% by weight of lactic acid; from about 12% to about 15% by weight of 1-octen-3-ol; from about 60% to about 65% by weight of the metallic base; from about 1% to about 2% by weight of an electrolyte; and from about 0.8% to about 1.5% by weight of the drying agent.

Yet another aspect of the instant invention provides an insect attracting system comprising a container with at least two compartments and a breathable cover and breathable walls, wherein a first compartment holds a carboxylic acid, and a second compartment holds a mixture of a metallic base and an electrolyte.

A preferred embodiment provides an insect attracting system wherein the metallic base is ammonium bicarbonate and the electrolyte is sodium chloride, with a further preferred embodiment comprising mixture of the metallic base and electrolyte with a drying agent. A further preferred embodiment provides a system wherein the drying agent is selected from magnesium sulfate, silica, and drierite, with the drying agent selected from magnesium sulfate, and silica being even further preferred. Yet another preferred embodiment provides an insect attracting system comprising from about 33% to about 35% by weight of lactic acid; from about 13 to about 15% by weight of hexanoic acid, from about 37% to about 39% by weight of the metallic base; and from about 3% to about 4% by weight of an electrolyte.

Another aspect of the instant invention provides an insect attracting system comprising a breathable container with a breathable lid comprising a mixture of a metallic base and an electrolyte. A preferred embodiment of this aspect provides an insect attracting system comprising from about 2% to about 20% by weight of an electrolyte and from about 98% to about 80% by weight of a metallic base. Another preferred embodiment provides an insect attracting system wherein the electrolyte is selected from sodium chloride, potassium chloride, sodium carbonate, sodium bicarbonate, sodium hydroxide, and calcium chloride. A further preferred embodiment provides an insect attracting system comprising from about 5% to about 10% by weight of an electrolyte and from about 95% to about 90% by weight of a metallic base, said insect attracting system further comprising a drying agent.

Provided in yet another preferred embodiment is an insect attracting system comprising from about 0.5% to about 2% by weight of a drying agent, from about 5% to about 10% by weight an electrolyte and from about 94.5% to about 88% by weight of a metallic base, wherein the metallic base is selected from ammonium bicarbonate, sodium carbonate, and sodium bicarbonate. A further preferred embodiment provides an insect attracting system wherein the metallic base is ammonium bicarbonate. Yet another further preferred embodiment provides an insect attracting system wherein the drying agent is selected from silica gel, magnesium sulfate, and drierite. A further preferred insect attracting system is one wherein the insect is a mosquito. Yet another further preferred insect attracting system is one wherein the electrolyte is sodium chloride.

Another aspect of the instant invention provides a method of attracting and trapping insects, wherein the method comprises: (a) providing an insect catching device capable of holding a container; (b) providing a composition comprising a metallic base, and an optional electrolyte; (c) placing the composition in a container having openings within the walls of the container and/or the lid of the container, and placing said container on or inside the insect catching device; (d) facilitating release of one or more gases from the metallic base and the optional electrolyte contained within the container; (e) attracting the insects to the gas released from the metallic base; and (f) utilizing the insect catching device to catch the insects attracted towards the insect catching device.

A preferred embodiment of this aspect of the present invention provides a method wherein the composition comprises from about 0% to about 20% by weight of an electrolyte and from about 100% to about 80% by weight of a metallic base. A further preferred embodiment provides a method wherein the composition comprises from about 2% to about 20% by weight of an electrolyte and from about 98% to about 80% by weight of a metallic base.

Another preferred embodiment provides a method wherein the electrolyte is selected from sodium chloride and sodium bicarbonate, and the metallic base is selected from ammonium bicarbonate, sodium carbonate, and sodium bicarbonate. A further preferred embodiment provides a method wherein the gas is released from the composition by elevating the temperature of the composition or by vibrating the container holding the composition. Another further preferred embodiment provides a method wherein the composition comprises a volatile solvent to help spread the gas released from the metallic base and electrolyte. Another further preferred embodiment provides a method wherein the metallic base is ammonium bicarbonate and the electrolyte is sodium chloride.

Another preferred embodiment provides a method wherein the composition comprises from about 5% to about 10% by weight of an electrolyte and from about 95% to about 90% by weight of the ammonium carbonate. A further preferred embodiment provides a method wherein the insect is a mosquito. Yet another further preferred embodiment provides a method wherein the gases released from the composition is ammonia and carbon dioxide.

Another aspect of the instant invention provides a method of attracting and trapping insects, wherein the method comprises: (a) providing an insect catching device capable of holding or accommodating a container; (b) providing a composition comprising a carboxylic acid, an alcohol, a mixture of a metallic base and an electrolyte, and an optional drying agent; (c) placing the composition in a container having openings within the walls of the container and/or the lid of the container, and placing said container on or inside the insect catching device; (d) facilitating release of one or more gases from the metallic base and the optional electrolyte contained within the container; (e) attracting the insects to the gas released from the metallic base; and (f) utilizing the insect catching device to catch the insects attracted towards the insect catching device.

A preferred embodiment of this aspect of the invention provides a method wherein: (i) the carboxylic acid is selected from lactic acid, hexanoic acid, and a mixture thereof; and (ii) the alcohol is selected from 1-octen-3-ol, ethanol, and mixtures thereof. A preferred aspect of this embodiment provides a method wherein the carboxylic acid is lactic acid, and the alcohol is 1-octen-3-ol. Another preferred embodiment provides a method wherein the carboxylic acid is hexanoic acid, and the alcohol is 1-octen-3-ol. Yet another aspect provides a method wherein the carboxylic acid is a mixture of lactic acid and hexanoic acid, and the alcohol is 1-octen-3-ol.

Yet another preferred aspect provides a method wherein the composition wherein the metallic base is ammonium bicarbonate and the electrolyte is sodium chloride. A further preferred aspect provides a method wherein the composition comprises a mixture of the metallic base and electrolyte further comprising a drying agent. A further preferred aspect provides a method wherein the drying agent is selected from magnesium sulfate, silica, and drierite. Yet another preferred embodiment provides a method wherein the composition further comprises an absorbent material soaked in the 1-octen-3-ol, wherein the absorbent material is a piece of cloth or sponge.

Yet another preferred embodiment provides a method wherein the composition comprises from about 8% to about 40% by weight of lactic acid; from about 7% to about 20% by weight of 1-octen-3-ol; from about 35% to about 85% by weight of a metallic base; from about 1% to about 5% by weight of an electrolyte; and from about 0% to about 12% by weight of a drying agent.

Another preferred aspect provides a method wherein the composition comprises from about 8% to about 30% by weight of lactic acid; from about 7% to about 15% by weight of 1-octen-3-ol; from about 45% to about 75% by weight of the metallic base; from about 1% to about 4% by weight of the electrolyte; and from about 0% to about 10% by weight of the drying agent.

Another preferred aspect provides a method wherein the composition comprises from about 12% to about 15% by weight of lactic acid; from about 12% to about 15% by weight of 1-octen-3-ol; from about 60% to about 65% by weight of the metallic base; from about 1% to about 2% by weight of an electrolyte; and from about 0.8% to about 1.5% by weight of the drying agent.

Another preferred aspect of the instant invention provides a method wherein the gas is released from the composition by elevating the temperature of the composition or by vibrating the container holding the composition. Yet another preferred aspect provides a method wherein the gas is released from the composition by elevating the temperature of the composition or by vibrating the container holding the composition.

A further preferred embodiment provides a method wherein the composition comprises a volatile solvent to help spread the gas released from the metallic base and electrolyte. A particularly preferred embodiment provides a method wherein the insect is a mosquito. Yet another particularly preferred embodiment provides a method wherein the gases released from the composition is ammonia and carbon dioxide.

Another aspect of the instant invention provides a method of attracting and trapping insects, wherein the method comprises: (a) providing an insect catching device capable of holding a container; (b) providing a composition comprising a carboxylic acid, an alcohol, a mixture of a metallic base and an electrolyte, and an optional drying agent; (c) placing the composition in a container having openings within the walls of the container and/or the lid of the container, and placing said container on or inside the insect catching device; (d) facilitating release of one or more gases from the metallic base and the optional electrolyte contained within the container; (e) attracting the insects to the gas released from the metallic base; and (f) utilizing the insect catching device to catch the insects attracted towards the insect catching device.

A preferred embodiment of this aspect provides a method wherein the composition comprises a mixture of lactic acid and hexanoic acid, a mixture of a metallic base and an electrolyte, and an optional drying agent. Another preferred embodiment provides a method wherein the metallic base is ammonium bicarbonate and the electrolyte is sodium chloride. A further preferred aspect provides a method wherein the mixture of the metallic base and electrolyte further comprises a drying agent. A preferred drying agent in this embodiment is selected from magnesium sulfate, silica, and drierite. A particularly preferred drying agent is selected from magnesium sulfate, and silica.

A further preferred embodiment provides a method wherein the composition comprises from about 33% to about 35% by weight of lactic acid; from about 13 to about 15% by weight of hexanoic acid, from about 37% to about 39% by weight of the metallic base; and from about 3% to about 4% by weight of an electrolyte.

Yet another further preferred embodiment provides a method wherein the composition comprises from about 20% to about 30% by weight of lactic acid; from about 14 to about 15% by weight of hexanoic acid, from about 38% to about 39% by weight of the metallic base; and from about 3% to about 4% by weight of an electrolyte.

Yet another preferred embodiment provides a method wherein the gas is released from the composition by elevating the temperature of the composition or by vibrating the container holding the composition. Yet another preferred embodiment provides a method wherein the gas is released from the composition by elevating the temperature of the composition or by vibrating the container holding the composition. A particularly preferred embodiment provides a method wherein the composition comprises a volatile solvent to help spread the gas released from the metallic base and electrolyte. A particularly preferred embodiment provides a method wherein the insect is a mosquito. Another particularly preferred embodiment provides a method wherein the gases released from the composition is ammonia and carbon dioxide.

The insect and mosquito bait as used herein, can be formulated with a suitable carrier, a gel matrix carrier can be a hydrolyzed protein gel material such as gelatin or a polysaccharide gel as disclosed by Williams in U.S. Pat. No. 6,790,436 in 2004. Another example carrier is a cooled paraffin wax and octenol solution mixed with salts of L-lactic acid, propionic acid, butyric acid, and valeric acid. The attractant compounds may also be volatilized from the liquid state directly from a wicking material with release rates controlled by head space and orifice size of a container.

The insect and mosquito bait formulations may be placed in any suitable container or device for dispensing the attractant compound and trapping insects. For example, the formulations can be placed in devices that promote evaporation of the chemical component(s) of the composition from a porous medium or wax-like medium containing the chemical component.

The foregoing description of the present invention has been presented for the purpose of illustration and description. It is not intended to be exhaustive as to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular uses contemplated. It is intended that the scope of the present invention be defined by the claims appended hereto.

Most efforts to control mosquito population are focused around the female mosquito. Adult female mosquitoes of several species are important vectors of human diseases. Due to a primarily hematophagous feeding strategy and the ability to produce offspring, most studies in mosquitoes have naturally focused on the adult female. Aedes aegypti, in particular, have received the majority of attention because of its ease of rearing, desiccation resistant eggs, cosmopolitan distribution and vector importance. Those factors have all converged to make Ae. aegypti a model organism. Nutrition strongly influences the physiology and behavior of mosquitoes. A sugar meal can sustain the energetic requirements of a female Ae. aegypti, and blood meals are required to produce eggs. However, much less is known about particular nutrients required during larval stages or about the importance of specific components of a sugar or blood meal in completing oogenesis.

### BRIEF DESCRIPTION OF THE DRAWINGS

FIG. 1: Depicted in FIG. 1 the UNO Plus stainless steel trap used to trap/catch the mosquitos.

FIG. 2: Depicted in FIG. 2 is the Dyantrap mosquito trap used to trap/catch mosquitos.

FIG. 3: This figure is a bar graph showing a comparison of the female and male Culex mosquitos caught using 9.07 g of pressure molded Ammonium Bicarbonate (AB) and 9.41 g of a pressure molded mixture of Ammonium Bicarbonate and 5% electrolyte (AB plus) respectively.

FIG. 4: This figure is a bar graph showing a comparison of the female and male mosquitos caught using 9.22 g of pressure molded Ammonium Bicarbonate (AB) and 9.22 g of a pressure molded mixture of Ammonium Bicarbonate and 5% electrolyte (AB plus) respectively.

FIG. 5: This figure is a bar graph showing a comparison of the female and male mosquitos caught using 8.65 g of pressure molded Ammonium Bicarbonate (AB) and 8.65 g of a pressure molded mixture of Ammonium Bicarbonate and 5% electrolyte (AB plus) respectively.

FIG. 6: This figure is a bar graph showing mosquito catch data using 9 gm pressure molded Ammonium Bicarbonate (AB) and 9 gm of pressure molded mixture of Ammonium Bicarbonate and 5% electrolyte respectively over a twenty-seven-day period.

FIG. 7: This figure is a bar graph showing comparison of mosquito catch using ammonium bicarbonate along with zero (0) to 7% by weight of an electrolyte (sodium chloride). The total weight of the samples was as shown below:

| No. | 1 | 2 | 3 | 4 |
|---|---|---|---|---|
| wt % of electrolyte | 0 | 2.5 | 5.0 | 7.0 |
| Total weight (g) | 9.325 | 9.386 | 9.424 | 9.464 |

FIG. 8: This figure is a bar graph showing comparison of mosquito catch using 20 g ammonium bicarbonate plus 5 g electrolyte (sodium chloride) vs only 20 gm of electrolyte (sodium chloride).

FIG. 9: This figure is a bar graph showing Culex mosquito (both male and female) catch using Sample #1 (a mixture of 5.2 g Pure Ammonium Bicarbonate+1.16 g 1-octen-3-ol+0.95 g Lactic Acid) and Sample #2 ((5.283 g Ammonium Bicarbonate+0.067 g electrolyte/salt)+1.13 g Octenol+0.8 g Lactic Acid) over a period of 32 days.

FIG. 10: This figure is a bar graph showing Aedes mosquito (both male and female) catch using Sample #1 (a mixture of 5.2 g Pure Ammonium Bicarbonate+1.16 g 1-octen-3-ol+0.95 g Lactic Acid) and Sample #2 ((5.283 g Ammonium Bicarbonate+0.067 g electrolyte/salt)+1.13 g Octenol+0.8 g Lactic Acid) over a period of 32 days.

### EXPERIMENTAL SECTION

As discussed elsewhere, the instant invention provides a method of attracting insects wherein the method comprises providing an insect bait for attracting insects, wherein the insect bait comprises ammonium bicarbonate and a bait-releasing means for enhancing the release of gas from the insect bait, wherein the gas releasing means atomizes the insect bait to release carbon dioxide to attract insects.

### Example 1

This system consists of just one ingredient, namely ammonium bicarbonate. The use of ammonium bicarbonate is the novel feature and it also imparts desirable properties to the system to attract mosquitoes. Ammonium bicarbonate is an important compound as it decomposes in to ammonia, carbon dioxide and water vapor:

NH₄HCO₃→NH₃+CO₂+H₂O

These three decomposition products attract mosquitoes. Here, CO₂ plays an important role in attracting mosquitos.

### Example 2

This system contains two ingredients: ammonium bicarbonate, and sodium chloride (an electrolyte).

The main difference between the two examples was ammonium bicarbonate (food grade) is used in Example 1, while a 5 wt % of an electrolyte was added to the ammonium bicarbonate in Example 2. The ammonium bicarbonate with the electrolyte showed better environmental stability as compared to the attractant made with the electrolyte.

Two mosquito traps labeled a #1 and #2 were used for the test. The attractants to be tested were placed in the attractant holder of the respective trap #1 for AB and #2 for AB plus type of attractant. The two traps were placed on the ground in a backyard (˜3 m×20 m), about 5-6 meter apart. The mosquitoes caught in each trap were collected every 24 hours and followed by number counting and species identification. The traps were rotated clockwise between two test sites every day after collected and replaced the bug boxes to eliminate the effect caused by the environmental factors. Culex mosquitoes were the predominant species being caught, and in particular, female Culex mosquitoes outnumbered male Culex mosquitoes as summarized in Tables IA and IB.

Table IA provides the mosquito catch comparison for male and female Culex mosquitos between Example 1 (Ammonium Bicarbonate—AB) and Example 2 (Ammonium Bicarbonate plus Electropyte (Sodium Chloride)—together AB Plus, over a period of nine (9) days.

TABLE IA

| | | Female Culex | | Male Culex | | Observations and notes in |
|---|---|---|---|---|---|---|
| | Weather | quinquefaciatus | | quinquefaciatus | | regard to the surrounding |
| Day # | Temp. ° C. | AB | AB plus | AB | AB plus | atmosphere and samples |
| 1 | 19~27, P-cloudy | 1 | 11 | 1 | 6 | |
| 2 | 18~27, P-cloudy | 10 | 8 | 1 | 2 | P-cloudy: Partly cloudy |
| 3 | 17~28, Cloudy | 1 | 6 | 5 | 10 | |
| 4 | 16~26, Cloudy | 31 | 22 | 11 | 3 | |
| 5 | 17~26, Sunny | 5 | 8 | 8 | 5 | |
| 6 | 18~28, P-cloudy | 2 | 40 | 4 | 1 | AB became mushy |
| 7 | 15~28, Sunny | 1 | 15 | 8 | 8 | |
| 8 | 15~28, Sunny | 8 | 10 | 5 | 10 | |
| 9 | 15~24, Sunny | 6 | 8 | 7 | 5 | AB disappeared |
| | | | | | | AB plus no change in shape |
| p value | | 0.154 | | 1.00 | | |
| (T-test) | | | | | | |

Table IB provides a sum of the total number of male and female Culex mosquitoes caught over a 9 day period using samples AB and AB Plus, outlined in more detail in Table IA.

TABLE IB

| | Female | Male |
|---|---|---|
| AB | 65 | 50 |
| AB plus | 128 | 50 |
| Ratio AB plus | 2.0 | 1.0 |
| vs. AB | | |

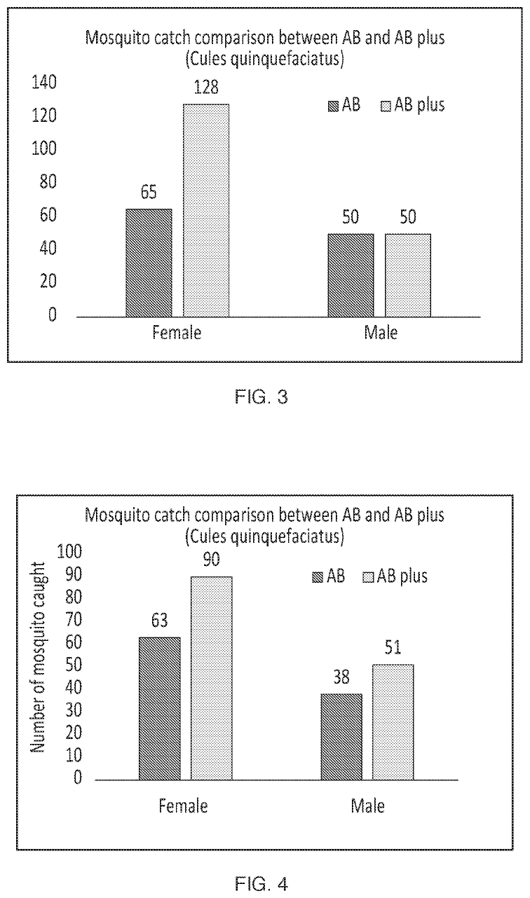

Tables IA and summarized in Table IB is the observation that AB catches roughly 30 percent more female Culex mosquitoes. However, adding an electrolyte (Sodium chloride) to the AB enhances the catch of the female Culex mosquitoes to almost twice the number and also the ratio of male to female mosquitoes caught goes from 1:1.3 (male:female) to about 1:2.5 (male:female), for a total ratio of male to female mosquitoes caught to 1:2. The data is also graphically represented in FIG. 3.

Some of the benefits of adding an electrolyte to the attractant ammonium bicarbonate include catching more female Culex quinquefaciatus compared to that for the only ammonium bicarbonate (a ratio of 2:1). Another observed benefit was that AB plus was stable and did not show any change in its shape during the 9 day test while AB decomposed over the 9-day period.

### Example 3

This example is a comparison of mosquitoes caught using 9.22 g of Ammonium Bicarbonate (AB) and AB Plus—namely a total of 9.22 g including both Ammonium Bicarbonate plus and electrolyte (namely sodium chloride). It should be noted that sample AB Plus showed better environmental stability compared to sample AB.

Two mosquito traps labeled a #1 and #2 were used for the test. The attractants to be tested were placed in the attractant holder of the respective trap #1 for AB and #2 for AB plus type of attractant. The two traps were placed on the ground in the backyard (˜3 m×20 m) of a ware house, about 5-6 meter apart. The mosquitoes caught in each trap were collected every 24 hours and followed by number counting and species identification. The traps were rotated clockwise between two test sites every day after collected and replaced the bug boxes to eliminate the effect caused by the environmental factors. Culex mosquitoes were the predominant species being caught, and in particular, female Culex mosquitoes outnumbered male Culex mosquitoes as summarized in Tables IIA and IIB.

Table IIA provides the mosquito catch comparison for male and female Culex mosquitos between Sample 1 (Ammonium Bicarbonate—AB) and Sample 2 (Ammonium Bicarbonate plus Electropyte (Sodium Chloride)—together AB Plus, over a period of nine (9) days.

TABLE IIA

| | | Female Culex | | Male Culex | | |
|---|---|---|---|---|---|---|
| 1. Test | Weather | quinquefaciatus | | quinquefaciatus | | |
| Day | (Temp. ° C.) | AB | AB plus | AB | AB plus | Notes |
| 1 | 14~25, Cloudy | 8 | 13 | 2 | 5 | |
| 2 | 16~26, Sunny | 11 | 3 | 4 | 5 | |
| 3 | 18~26, Sunny | 5 | 6 | 2 | 0 | |
| 4 | 18~27, Sunny | 8 | 8 | 5 | 5 | |
| 5 | 17~29, Sunny | 8 | 11 | 6 | 5 | |
| 6 | 19~28, Cloudy | 4 | 13 | 5 | 6 | AB became mushy |
| 7 | 16~24, Cloudy | 5 | 8 | 3 | 5 | |
| 8 | 17~25, Cloudy | 9 | 13 | 4 | 8 | |
| 9 | 13~23, cloudy | 5 | 15 | 7 | 12 | AB disappeared |
| | | | | | | AB plus no chang |
| | | | | | | in shape |
| Total | | 63 | 90 | 38 | 51 | |
| p value | | 0.127 | | 0.10 | | |
| (T-test) | | | | | | |

Table IIB provides a sum of the total number of male and female Culex mosquitoes caught over a 9 day period using samples AB and AB Plus, outlined in more detail in Table IIA.

TABLE IIB

| | Female | Male |
|---|---|---|
| AB | 63 | 38 |
| AB plus | 90 | 51 |
| Ratio AB | 1.8 | 1.1 |
| plus | | |
| vs. AB | | |

Tables IIA and summarized in Table IIB is the observation that AB catches roughly 50 percent more female Culex mosquitoes. However, adding an electrolyte (Sodium chloride) to the AB enhances the catch of the female Culex mosquitoes to almost 80 percent. The data is also graphically represented in FIG. 4.

Some of the benefits of adding an electrolyte to the attractant ammonium bicarbonate include catching more female Culex quinquefaciatus compared to that for the only ammonium bicarbonate (a ratio of 2:1). Another observed benefit was that AB plus was stable and did not show any change in its shape during the 9 day test while AB decomposed over the 9 day period.

### Example 4

This example is a comparison of mosquitoes caught using 8.65 g of Ammonium Bicarbonate (AB) and AB Plus—namely a total of 8.85 g including both Ammonium Bicarbonate plus and 5% electrolyte (namely sodium chloride). The samples were sealed in respective containers having an opening of approximately 5 mm on the side of the respective container. It should be noted that sample AB Plus showed better environmental stability compared to sample AB.

Two mosquito traps labeled a #1 and #2 were used for the test. The attractants to be tested were placed in the attractant holder of the respective trap #1 for AB and #2 for AB plus type of attractant. The two traps were placed on the ground in the backyard (˜3 m×20 m) of a warehouse, about 5-6 meter apart. The mosquitoes caught in each trap were collected every 24 hours and followed by number counting and species identification. The traps were rotated clockwise between two test sites every day after being collected and replaced the bug boxes to eliminate the effect caused by the environmental factors. Culex mosquitoes were the predominant species being caught, and in particular, female Culex mosquitoes outnumbered male Culex mosquitoes as summarized in Tables IIIA and IIIB.

Table IIIA provides the mosquito catch comparison for male and female Culex mosquitos between Example 1 (Ammonium Bicarbonate—AB) and Example 2 (Ammonium Bicarbonate plus Electropyte (Sodium Chloride)—together AB Plus, over a period of nine (9) days.

TABLE IIIA

| | | Female Culex | | Male Culex | | |
|---|---|---|---|---|---|---|
| Test | Weather | quinquefaciatus | | quinquefaciatus | | |
| Day | (Temp. ° C.) | AB | AB plus | AB | AB plus | Notes |
| 1 | 14~23, Sunny | 8 | 15 | 5 | 8 | |
| 2 | 15~24, Sunny | 7 | 25 | 9 | 5 | |
| 3 | 15~25, Sunny | 8 | 12 | 9 | 6 | |
| 4 | 11~21, Sunny | 6 | 19 | 6 | 15 | |
| 5 | 12~20, P-Cloudy | 16 | 20 | 11 | 8 | P-cloudy: Partly cloudy |
| 6 | 10~21, Cloudy | 7 | 10 | 10 | 8 | AB became mushy |
| 7 | 11~14, Cloudy | 7 | 20 | 3 | 9 | |
| 8 | 6~12, Sunny | 12 | 15 | 6 | 13 | |
| 9 | 9~20, P-cloudy | 12 | 14 | 15 | 12 | AB diappeared; AB plus |
| | | | | | | still in orignal shape & |
| | | | | | | little shrinkage in volume |
| Total | | 83 | 150 | 74 | 84 | |

| | | |
|---|---|---|
| p value(T-test) | 0.005 | 0.53 |

Table IIIB provides a sum of the total number of male and female Culex mosquitoes caught over a 9 day period using samples AB and AB Plus, outlined in more detail in Table IIIA.

TABLE IIIB

| | Female | Male |
|---|---|---|
| AB | 83 | 74 |
| AB plus | 150 | 84 |
| Ratio AB | 1.8 | 1.1 |
| plus | | |
| vs. AB | | |

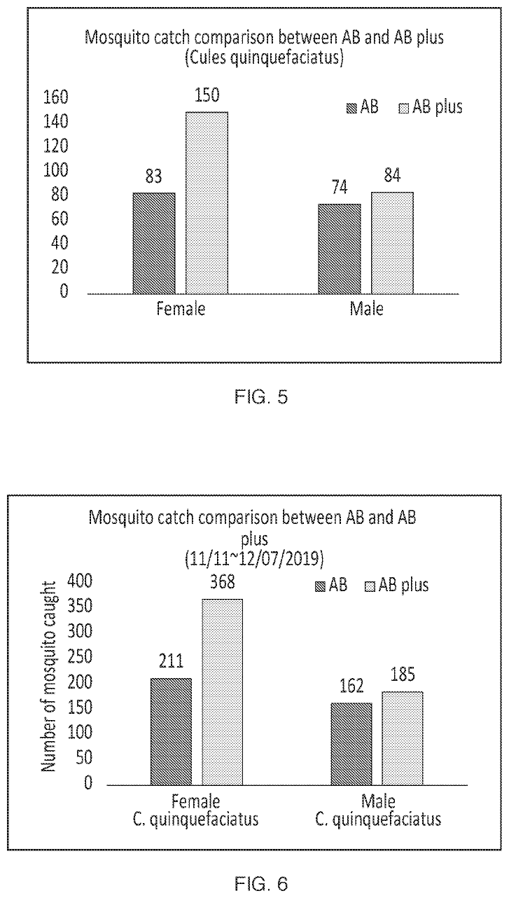

Tables IIIA and summarized in Table IIIB is the observation that AB catches roughly 15 percent more female Culex mosquitoes. However, adding an electrolyte (Sodium chloride) to the AB enhances the catch of the female Culex mosquitoes to almost 80 percent. The data is also graphically represented in FIG. 5.

Some of the observations include attractant of ammonium bicarbonate with 5% of the electrolyte (AB Plus) caught 80% more female Culex quinquefaciatus than solely for ammonium bicarbonate (AB), showing a significant increase in the attractiveness to female Culex quinquefaciatus mosquito. The p-value in the statistic pair comparison between the daily mosquito catching number of two attractants was 0.005 which is much lower than 0.5. AB plus showed a good outdoor stability with lower shrinkage in the volume and no change in shape. The AB attractant made with pure ammonium bicarbonate showed apparent decomposition after 6 day test and totally decomposed on day 9.

### Example 5

This example is a comparison of mosquitoes caught using 9 g of Ammonium Bicarbonate (AB) and AB Plus—namely a total of 9 g including both Ammonium Bicarbonate plus and 5% electrolyte (namely sodium chloride). The samples were sealed in respective containers having an opening of approximately 5 mm on the side of the respective container. It should be noted that sample AB Plus showed better environmental stability compared to sample AB.

Two mosquito traps labeled a #1 and #2 were used for the test. The attractants to be tested were placed in the attractant holder of the respective trap #1 for AB and #2 for AB plus type of attractant. The two traps were placed on the ground in the rectangular backyard (˜3 m×20 m), about 5-6 meter apart. The mosquitoes caught in each trap were collected every 24 hours and followed by number counting and species identification. The traps were rotated clockwise between two test sites every day after collected and replaced the bug boxes to eliminate the effect caused by the environmental factors. Culex mosquitoes were the predominant species being caught, and in particular, female Culex mosquitoes outnumbered male Culex mosquitoes as summarized in Tables IVA and IVB.

Table IVA provides the mosquito catch comparison for male and female Culex mosquitos between Example 1 (Ammonium Bicarbonate—AB) and Example 2 (Ammonium Bicarbonate plus Electropyte (Sodium Chloride)—together AB Plus, over a period of twenty seven (27) days.

TABLE IVA

| | Female Culex | | Male Culex | |
|---|---|---|---|---|
| | Mosquitoes | | Mosquitoes | |
| | Caught | | Caught | |
| | | AB | | AB |
| Day | AB | plus | AB | plus |
| 1 | 1 | 11 | 1 | 6 |
| 2 | 10 | 8 | 1 | 2 |
| 3 | 1 | 6 | 5 | 10 |
| 4 | 31 | 22 | 11 | 3 |
| 5 | 5 | 8 | 8 | 5 |
| 6 | 2 | 40 | 4 | 1 |
| 7 | 1 | 15 | 8 | 8 |
| 8 | 8 | 10 | 5 | 10 |
| 9 | 6 | 8 | 7 | 5 |
| 10 | 8 | 13 | 2 | 5 |
| 11 | 11 | 3 | 4 | 5 |
| 12 | 5 | 6 | 2 | 0 |
| 13 | 8 | 8 | 5 | 5 |
| 14 | 8 | 11 | 6 | 5 |
| 15 | 4 | 13 | 5 | 6 |
| 16 | 5 | 8 | 3 | 5 |
| 17 | 9 | 13 | 4 | 8 |
| 18 | 5 | 15 | 7 | 12 |
| 19 | 8 | 15 | 5 | 8 |
| 20 | 7 | 25 | 9 | 5 |
| 21 | 8 | 12 | 9 | 6 |
| 22 | 6 | 19 | 6 | 15 |
| 23 | 16 | 20 | 11 | 8 |
| 24 | 7 | 10 | 10 | 8 |
| 25 | 7 | 20 | 3 | 9 |
| 26 | 12 | 15 | 6 | 13 |
| 27 | 12 | 14 | 15 | 12 |
| Total | 211 | 368 | 162 | 185 |
| P-value | 0.002 | | 0.3 | |

Table IVB provides a sum of the total number of male and female Culex mosquitoes caught over a 9 day period using samples AB and AB Plus, outlined in more detail in Table IVA.

TABLE IVB

| | Female | Male |
|---|---|---|
| | C. | C. |
| | quinquefaciatus | quinquefaciatus |
| AB | 211 | 162 |
| AB | 368 | 185 |
| plus | | |

Tables IVA and summarized in Table IVB is the observation that AB catches roughly 30 percent more female Culex mosquitoes. However, adding an electrolyte (Sodium chloride) to the AB enhances the catch of the female Culex mosquitoes to almost 100 percent. The data is also graphically represented in FIG. 6.

### Example 6

This example is a comparison of mosquitoes caught using different combinations of AB and AB Plus as indicated below:

| Sample No. | 1 | 2 | 3 | 4 |
|---|---|---|---|---|
| wt % of electrolyte | 0 | 2.5 | 5.0 | 7.0 |
| (NaCl) | | | | |
| Total weight (g) | 9.325 | 9.386 | 9.424 | 9.464 |

The samples were sealed in respective containers having an opening of approximately 5 mm on the side of the respective container. It should be noted that sample AB Plus showed better environmental stability compared to sample AB.

Ammonium bicarbonate and the electrolyte were mixed and molded in to a round block (14 mm thick & 25 mm in diameter) that was sealed in a round plastic box with a release hole (5 mm in dia) on top. Four mosquito traps labeled as #1, #2 , #3 & #4 that were hung on the branch of the tree nearby, about 1-1.5 meter above ground and 10 meters apart. Attractants to be tested were placed in the attractant holder of each trap. The mosquitoes caught in each trap were collected every 24 hours, at about 8:30 am every day, and counted along with species identification. The traps were rotated clockwise between four test sites every day after collecting and replacing the bug boxes to eliminate the effect caused by the environmental factors. Culex mosquitoes were the predominant species being caught, and in particular, female Culex mosquitoes outnumbered male Culex mosquitoes as summarized in Tables VA and VB.

Table VA provides the mosquito catch comparison for male and female Culex mosquitos between Example 1 (Ammonium Bicarbonate—AB) and Example 2 (Ammonium Bicarbonate plus electrolyte (Sodium Chloride)—together AB Plus, over a period of sixteen (16) days.

TABLE VA

| | Trap#1(0%) | | Trap#2 (2.5%) | | Trap#3 (5%) | | Trap#4 (7%) | |
|---|---|---|---|---|---|---|---|---|
| Mosquito | Culex quinquefaciatus | | | | | | | |
| Day | Female | Male | Female | Male | Female | Male | Female | Male |
| 1 | 7 | 7 | 3 | 5 | 12 | 8 | 10 | 9 |
| 2 | 1 | 6 | 8 | 15 | 18 | 14 | 5 | 10 |
| 3 | 2 | 7 | 10 | 6 | 16 | 3 | 8 | 1 |
| 4 | 2 | 6 | 6 | 1 | 15 | 1 | 16 | 7 |
| 5 | 4 | 4 | 3 | 1 | 10 | 2 | 6 | 3 |
| 6 | 3 | 3 | 3 | 2 | 5 | 0 | 5 | 3 |
| 7 | 5 | 4 | 5 | 0 | 4 | 1 | 4 | 2 |
| 8 | 3 | 3 | 2 | 4 | 1 | 1 | 5 | 3 |
| 9 | 4 | 3 | 0 | 2 | 15 | 5 | 5 | 5 |
| 10 | 3 | 2 | 1 | 1 | 18 | 0 | 2 | 0 |
| 11 | 3 | 2 | 10 | 2 | 5 | 0 | 10 | 1 |
| 12 | 11 | 6 | 6 | 0 | 1 | 0 | 5 | 0 |
| 13 | 7 | 2 | 10 | 2 | 12 | 1 | 2 | 4 |
| 14 | 10 | 2 | 33 | 0 | 23 | 0 | 8 | 0 |
| 15 | 10 | 2 | 13 | 10 | 23 | 0 | 10 | 2 |
| 16 | 9 | 10 | 18 | 0 | 22 | 0 | 15 | 0 |
| Total | 84 | 69 | 131 | 51 | 200 | 36 | 116 | 50 |

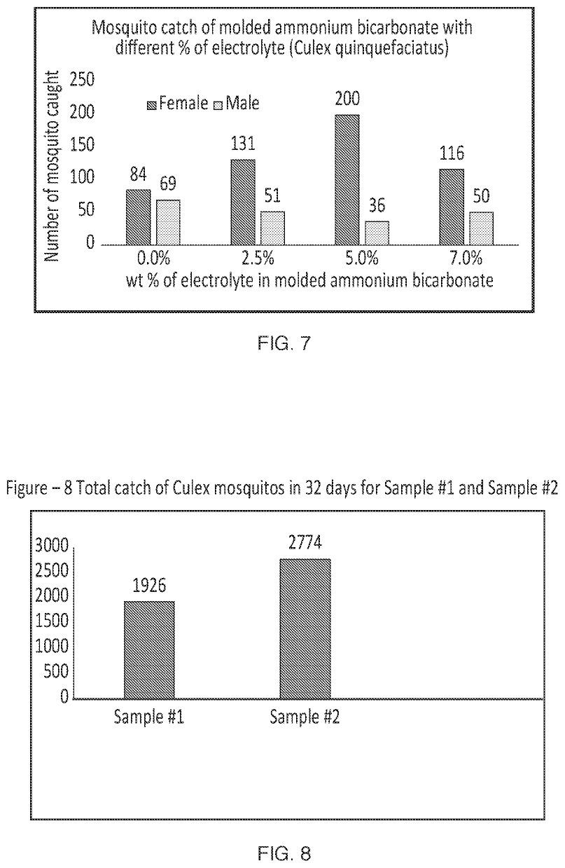

Tables VA and summarized in Table VB is the observation that adding an electrolyte (Sodium chloride) to AB enhances the catch of the female Culex mosquitoes to almost 600 percent as compared with the male mosquitoes, see combination of AB Plus with 5% electrolyte. The data is also graphically represented in FIG. 7.

TABLE VB

| % of electrolyte | 0% | 2.5% | 5% | 7% |
|---|---|---|---|---|
| Female Culex | 84 | 131 | 200 | 116 |
| quinquefaciatus | | | | |
| Male Culex | 69 | 51 | 36 | 50 |
| quinquefaciatus | | | | |

### Example 7

This example is a comparison of mosquitoes caught using different combinations of AB and AB Plus as indicated below:

| No. | 1 | 2 | 3 | 4 |
|---|---|---|---|---|
| wt % of electrolyte | 0 | 10 | 15.0 | 20.0 |
| Total weight (g) | 9.416 | 9.485 | 9.428 | 9.458 |

The samples were sealed in respective containers having an opening of approximately 5 mm on the side of the respective container. It should be noted that sample AB Plus showed better environmental stability compared to sample AB.

Ammonium bicarbonate and the electrolyte were mixed and molded in to a round block (14 mm thick & 25 mm in diameter) that was sealed in a round plastic box with a release hole (5 mm in dia) on top. Four mosquito traps labeled as #1, #2 , #3 & #4 that were hung on the branch of the tree nearby, about 1-1.5 meter above ground and 10 meters apart. Attractants to be tested were placed in the attractant holder of each trap. The mosquitoes caught in each trap were collected every 24 hours, at about 8:30 am every day, and counted along with species identification. The traps were rotated clockwise between four test sites every day after collecting and replacing the bug boxes to eliminate the effect caused by the environmental factors. Culex mosquitoes were the predominant species being caught, and in particular, female Culex mosquitoes outnumbered male Culex mosquitoes as summarized in Tables VIA and VIB.

Table VIA provides the mosquito catch comparison for male and female Culex mosquitos between Example 1 (Ammonium Bicarbonate—AB) and Example 2 (Ammonium Bicarbonate plus electrolyte (Sodium Chloride)—together AB Plus, over a period of sixteen (16) days.

TABLE VIA

| | Trap#1(0%) | | Trap#2(10%) | | Trap#3(15%) | | Trap#4(20%) | |
|---|---|---|---|---|---|---|---|---|
| Mosquito | Culex quinquefaciatus | | | | | | | |
| Date | Female | Male | Female | Male | Female | Male | Female | Male |
| 1 | 10 | 5 | 10 | 2 | 10 | 6 | 5 | 6 |
| 2 | 5 | 10 | 15 | 9 | 12 | 6 | 10 | 5 |
| 3 | 7 | 7 | 4 | 5 | 7 | 2 | 5 | 3 |
| 4 | 2 | 7 | 8 | 1 | 10 | 8 | 12 | 4 |
| 5 | 5 | 6 | 9 | 4 | 4 | 0 | 6 | 7 |
| 6 | 4 | 5 | 6 | 4 | 8 | 8 | 15 | 2 |
| 7 | 2 | 5 | 4 | 4 | 10 | 1 | 5 | 1 |
| 8 | 2 | 9 | 3 | 3 | 6 | 3 | 10 | 3 |
| 9 | 2 | 3 | 2 | 3 | 2 | 5 | 5 | 4 |
| 10 | 5 | 2 | 5 | 0 | 8 | 2 | 5 | 2 |
| 11 | 10 | 5 | 5 | 4 | 2 | 4 | 8 | 6 |
| 12 | 2 | 4 | 7 | 7 | 2 | 6 | 2 | 4 |
| 13 | 2 | 1 | 4 | 2 | 4 | 7 | 4 | 0 |
| 14 | 6 | 2 | 10 | 2 | 5 | 2 | 5 | 3 |
| 15 | 0 | 8 | 1 | 3 | 2 | 0 | 5 | 6 |
| 16 | 2 | 23 | 3 | 3 | 4 | 3 | 3 | 2 |
| Total | 66 | 102 | 96 | 56 | 96 | 63 | 105 | 58 |

Tables VIA and summarized in Table VIB is the observation that adding an electrolyte (Sodium chloride) to AB enhances the catch of the female Culex mosquitoes to almost 80 percent, see combination of AB Plus with 10% electrolyte.

TABLE VIB

| % of electrolyte | 0% | 10.0% | 15% | 20% |
|---|---|---|---|---|
| Female Culex | 66 | 96 | 96 | 105 |
| quinquefaciatus | | | | |
| Male Culex | 102 | 56 | 63 | 58 |
| quinquefaciatus | | | | |

### Example 8

This example provides a comparison of mosquitoes caught using 5.2 g Ammonium Bicarbonate+1.16 g Octenol+0.95 g Lactic Acid (Sample 1) and 5.283 g Ammonium Bicarbonate+0.067 g salt)+1.13 g Octenol+0.8 g Lactic Acid (Sample2). The samples were sealed in respective containers having an opening of approximately 5 mm on the side of the respective container.

Two mosquito traps labeled a #1 and #2 were used for the test. The attractants to be tested were placed in the attractant holder of the respective trap #1 for Sample land #2 for Sample 2. The two traps were placed on the ground in the rectangular backyard (˜3 m×20 m), about 5-6 meter apart. The mosquitoes caught in each trap were collected every 24 hours and followed by number counting and species identification. The traps were rotated clockwise between two test sites every day after collected and replaced the bug boxes to eliminate the effect caused by the environmental factors. Culex mosquitoes were the predominant species being caught as summarized in Tables VIIA and VIIB.

Table VIIA provides the count of mosquitoes caught over a period of 32 days using the composition comprising 5.2 g Ammonium Bicarbonate+1.16 g Octenol+0.95 g Lactic Acid (Sample 1).

TABLE VIIA

| | Relative | Highest | | | | Aedes | |
|---|---|---|---|---|---|---|---|
| | Humidity | Temperatue | | Culex | | albopictus | |
| Day | (%) | (° C.) | Location | Female | Male | Female | Male |
| 1 | 72 | 25 | A | 33 | 64 | 1 | 1 |
| 2 | 60 | 27 | B | 16 | 53 | 2 | |
| 3 | 56 | 23 | A | 24 | 47 | 1 | |
| 4 | 70 | 23 | B | 9 | 2 | | |
| 5 | 76 | 23 | A | 16 | 31 | | |
| 6 | 80 | 24 | B | 11 | 11 | | |
| 7 | 72 | 21 | A | 28 | 61 | | |
| 8 | 66 | 24 | B | 15 | 17 | | |
| 9 | 68 | 23 | A | 16 | 68 | | |
| 10 | 70 | 26 | B | 25 | 72 | | 2 |
| 11 | 62 | 27 | A | 55 | 38 | | |
| 12 | 70 | 27 | B | 18 | 15 | | |
| 13 | 70 | 28 | A | 32 | 28 | | 1 |
| 14 | 60 | 26 | B | 20 | 77 | 2 | |
| 15 | 62 | 28 | A | 32 | 96 | 1 | 1 |
| 16 | 63 | 29 | B | 16 | 36 | | 3 |
| 17 | 66 | 28 | A | 10 | 32 | | |
| 18 | 68 | 29 | B | 5 | 43 | 2 | 4 |
| 19 | 66 | 30 | A | 14 | 47 | 1 | |
| 20 | 68 | 30 | B | 11 | 35 | 2 | 4 |
| 21 | 54 | 21 | A | 25 | 107 | 1 | |
| 22 | 46 | 21 | B | 12 | 70 | 2 | 2 |
| 23 | 44 | 21 | A | 21 | 94 | 1 | |
| 24 | 60 | 25 | B | 8 | 8 | 1 | |
| 25 | 70 | 23 | A | 9 | 25 | 1 | |
| 26 | 58 | 28 | B | 12 | 35 | 2 | 1 |
| 27 | 74 | 27 | A | 18 | 31 | 2 | |
| 28 | 76 | 29 | B | 9 | 29 | 1 | |
| 29 | 78 | 30 | A | 5 | 14 | 1 | |
| 30 | 78 | 31 | B | 15 | 18 | | |
| 31 | 76 | 30 | A | 10 | 33 | 1 | |
| 32 | 78 | 30 | B | 10 | 29 | | 4 |

| | | | | |
|---|---|---|---|---|
| Subtotal | 560 | 1366 | 25 | 23 |

| | | |
|---|---|---|
| Total | 1926 | 48 |

Table VIIB provides the count of mosquitoes caught over a period of 32 days using the composition comprising 5.283 g Ammonium Bicarbonate+0.067 g salt)+1.13 g Octenol+0.8 g Lactic Acid (Sample2).

TABLE VIIB

| | yRelative | Highest | | | | Aedes | |
|---|---|---|---|---|---|---|---|
| | Humidity | Temperatue | | Culex | | albopictus | |
| Day | (%) | (° C.) | Location | Female | Male | Female | Male |
| 1 | 72 | 25 | B | 15 | 20 | 1 | |
| 2 | 60 | 27 | A | 19 | 80 | 1 | |
| 3 | 56 | 23 | B | 35 | 19 | | |
| 4 | 70 | 23 | A | 20 | 31 | 2 | |
| 5 | 76 | 23 | B | 12 | 0 | 2 | |
| 6 | 80 | 24 | A | 59 | 28 | 2 | |
| 7 | 72 | 21 | B | 28 | 55 | 2 | |
| 8 | 66 | 24 | A | 27 | 48 | | |
| 9 | 68 | 23 | B | 18 | 15 | 2 | |
| 10 | 70 | 26 | A | 31 | 94 | 1 | |
| 11 | 62 | 27 | B | 63 | 89 | 3 | 2 |
| 12 | 70 | 27 | A | 48 | 55 | | |
| 13 | 70 | 28 | B | 28 | 35 | 2 | |
| 14 | 60 | 26 | A | 38 | 73 | 1 | |
| 15 | 62 | 28 | B | 35 | 80 | 1 | |
| 16 | 63 | 29 | A | 42 | 55 | 2 | |
| 17 | 66 | 28 | B | 28 | 41 | 5 | 1 |
| 18 | 68 | 29 | A | 12 | 47 | 1 | 1 |
| 19 | 66 | 30 | B | 15 | 56 | 2 | |
| 20 | 68 | 30 | A | 38 | 73 | 2 | 3 |
| 21 | 54 | 21 | B | 88 | 148 | 2 | |
| 22 | 46 | 21 | A | 38 | 110 | 2 | |
| 23 | 44 | 21 | B | 25 | 85 | 2 | 2 |
| 24 | 60 | 25 | A | 63 | 92 | 3 | |
| 25 | 70 | 23 | B | 33 | 86 | 3 | 2 |
| 26 | 58 | 28 | A | 11 | 18 | 1 | |
| 27 | 74 | 27 | B | 35 | 58 | 2 | 1 |
| 28 | 76 | 29 | A | 15 | 35 | 2 | |
| 29 | 78 | 30 | B | 18 | 20 | 2 | 1 |
| 30 | 78 | 31 | A | 10 | 16 | 1 | |
| 31 | 76 | 30 | B | 32 | 68 | 2 | |
| 32 | 78 | 30 | A | 30 | 35 | 2 | 1 |

| | | | | |
|---|---|---|---|---|
| Subtotal | 1009 | 1765 | 56 | 14 |

| | | |
|---|---|---|
| Total | 2774 | 70 |

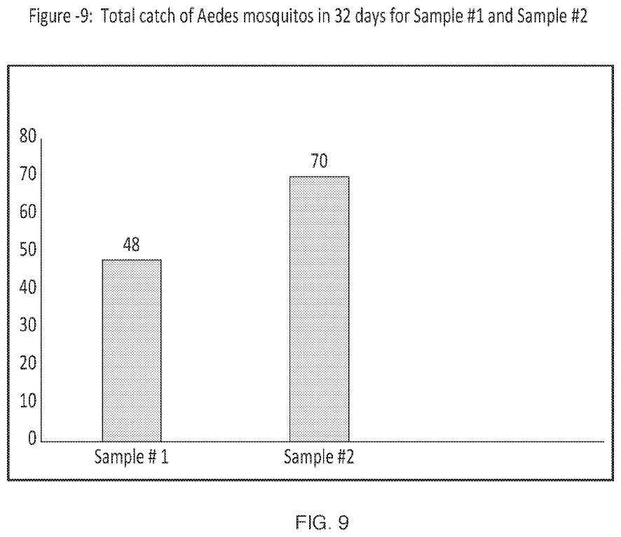

Data in Tables VIIA and VIIB demonstrate that that adding an electrolyte (Sodium chloride) to the composition (Sample 2) enhances the catch of the Culex mosquitoes by almost 50 percent (2774 Culex mosquitos caught) over a composition without an electrolyte (Sample 1) (1926 Culex mosquitos caught). Also worth noting is that Sample 2 helped catch twice the number of female Culex mosquitoes (1009) as compared with Sample 1 (560). Also worth noting is the fact that Culex mosquitoes were the overwhelming variety caught as opposed to Aedes mosquitoes (about 98:2). Graphically represented in FIG. 8 is number of Culex mosquitoes caught using Samples 1 and 2. Graphically represented in FIG. 9 is number of Aedes mosquitoes caught using Samples 1 and 2.

### Example 9

Example 9 provides a composition, total weight 8.556 g, comprising a mixture of carboxylic acids (Lactic acid and Hexanoic Acid) a metallic base (Ammonium Bicarbonate), an electrolyte (Sodium Chloride) and an absorbent material (cloth) wherein the cloth is used to absorb the liquid (hexanoic acid).

| | | % of |
|---|---|---|
| Composition | Weight (gram) | Composition |
| Lactic Acid | 3 | 35.1% |
| Hexanoic Acid | 1.2 | 14.0% |
| Metallic base | 3.3 | 38.6% |
| Electrolyte | 0.3 | 3.5% |
| PET non-Woven cloth pod | 0.756 | 8.8% |
| Total | 8.556 | 100 |

### Example 10

Example 10 provides a composition, total weight 8.293 g, comprising a mixture of carboxylic acid (Lactic acid) a non-metallic base (Ammonium Bicarbonate), an electrolyte (Sodium Chloride), an alcohol (1-octen-3-ol), a drying agent (silica) and an absorbent material (cloth) wherein the cloth is used to absorb the liquid (1-octen-3-ol).

| | | % by |
|---|---|---|
| | Weight | weight of |
| Composition | (gram) | composition |
| Lactic Acid | 1.2 | 14.5% |
| 1-octen-3-ol | 1.1 | 13.3% |
| Non-metallic base | 5.23 | 63.1% |
| Electrolyte | 0.07 | 0.8% |
| Drying agent | 0.1 | 1.2% |
| PET non-Woven cloth | 0.593 | 7.2% |
| Total | 8.293 | 100 |

Mosquito catch date demonstrate that female mosquitoes are trapped/caught at a significantly higher rate than male mosquitoes. As mentioned above, adult female mosquitoes of are important vectors of human diseases. Due to a primarily hematophagous feeding strategy and the ability to produce offspring catching/trapping and eliminating adult female mosquitoes is more important.

### DESCRIPTIONS OF FIGURES

Description of FIGS. 3-9 are provided elsewhere.

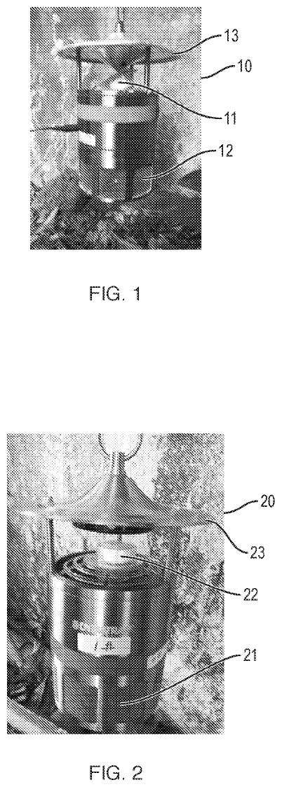

FIG. 1 depicts an insect catching device 10 comprising a container 11, said container capable of holding the compositions mentioned in the specification, and an enclosed fan 12, and an insect trapping portion 13. As used herein, the different phrases will have the meanings as described in this and other sections of the application.

FIG. 2 depicts an insect catching device 20 comprising a container 21, said container capable of holding the compositions mentioned in the specification, and an enclosed fan 22, and an insect trapping portion 23. As used herein, the different phrases will have the meanings as described in this and other sections of the application.

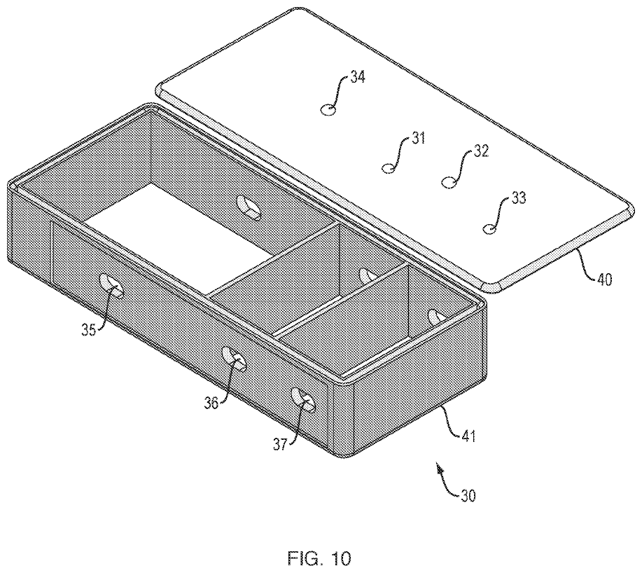

FIG. 10 depicts a container used in the instant invention to hold the compositions discussed in the instant invention. This container, 30, comprises of a lid 40 and walls 41, with the lid and walls having holes 31, 32, 33, 34, 35, 37, and 37 in them to facilitate the movement of gases generated by the compositions of the instant invention.

### Definitions

As used herein, the different phrases will have the meanings as described in this and other sections of the application.

The term “insect attracting system” as used herein represents a combination of multiple components including individual chemical entities, mixture of two or more chemical entities, physical embodiments including a container, trapping devices to enable trapping insects including mosquitos, and other components known to one skilled in the art to help practice the instant invention.

The term “at least” is used to indicate that a given embodiment consists of at least the number of components indicated. It is understood that a given embodiment can consist of more than the at least number of components indicated. The term “at least” is to be construed to define the lower limit of components and not the upper limit of components. It is further understood that the instantly claimed insect attracting system can comprise up to but no more than 25 components.

The term “breathable” as used herein refers to the ability of the container wall or lid to facilitate movement of gases from within the container to the outside and vice versa. The breathability comes from the walls and lid having holes or a mesh like arrangement.

The terms “metallic base” and “non-metallic base” are used herein, are intended to a compound with basic pH wherein generally the pH is greater than about 8. A metallic base compound contains one or more metal elements bonded to another element. Typically, the metal atom acts as the cation in the compound and is bonded to a nonmetallic anion or an ionic group. Because it has a positive charge, the metal element symbol is listed first in the chemical formula. Ammonium ion is being considered as a metal element for the purposes of this invention. Illustrative examples of metallic base are ammonium bicarbonate, sodium carbonate, sodium bicarbonate, and organic and inorganic potassium and sodium salts. It is understood that the terms metallic base and non-metallic base are interchangeable.

The “housing” as used herein represents a physical container which can hold/accommodate at least some of the components of the instant invention. A typical housing will have multiple independent zones/compartments separated by a partition such that each zone/compartment respectively holds, for example, the (a) saturated, partially unsaturated, or an aromatic alcohol; (b) L (+) lactic acid; and (c) a metallic or metallic base. A typical housing will also have a lid/cover to encase the multiple independent zones/compartments. The housing can be made from different materials such as plastic, metal, wood, or combinations thereof. The housing material typically would not interact/react with the materials it holds/accommodates. An illustrative example of a housing is depicted below in FIG. 1.

The term “inert binding agent” as used herein represents a material that functions as a binding agent to enable formulating the metallic or non-metallic base in to a compressed form such as a tablet. As the term suggests, the inert binding agent is inert and as such does not interact with the metallic or non-metallic base material. Illustrative examples of an inert binding material include corn starch, microcrystalline cellulose, povidone polyvinylpyrrolidone and modified cellulose, wax, and stearate salt.

The term “electrolyte” as used herein represents a material capable of producing an electrically conducting solution when combined or dissolved in a solvent, preferably a polar solvent such as water. Illustrative examples of an electrolyte are phosphate and other salts including sodium chloride, potassium chloride, sodium carbonate, sodium bicarbonate, sodium hydroxide, calcium chloride, chloric acid, nitric acid, hydrochloric acid, and magnesium hydroxide.

The term “drying agent” as used herein represents a chemical agent capable of absorbing moisture/water in an environment, such as humid air, where moisture exists. Water absorption can occur wherein the drying agent adsorbs water on its surface or in the pores of the matrices that may exist within the agent. Illustrative examples of drying agents are silica gel, molecular sieves, aluminum oxide, magnesium sulfate, calcium chloride, sodium sulfate, diorite, potassium carbonate, sodium sulfate, and sodium hydroxide.

The term “carboxylic acid” as used herein is intended to represent an organic acid that contains a carboxyl group (C(═O)OH) attached to an R-group. The general formula of a carboxylic acid is R—COOH or R—CO₂H, with R referring to an alkyl, alkenyl, aryl, or other groups. Illustrative subclasses of carboxylic acids include amino acids and fatty acids. Illustrative examples of carboxylic acids are formic acid, benzoic acid, lactic acid, hexanoic acid, acetic acid, propionic acid, capric acid, docosahexaenoic acid and eicosapentaenoic acid, pyruvic acid, salicylic acid, adipic acid, isocytric acid, and glycolic acid. It is understood that the terms L-lactic acid and Lactic acid are interchangeable.

The terms “insect bait” or “mosquito bait” or “bait” as used herein refers to a composition that is capable to releasing gases that attract insects, including mosquitoes. These terms also include the gases released from the compositions including carbon dioxide (CO₂), ammonia (NH₃), propane, and the like that attract insects including mosquitoes.

The term “alcohol” as used herein represents a class of organic compounds characterized by one or more hydroxyl (—OH) groups attached to a carbon atom of an alkyl group (hydrocarbon chain). Some consider alcohols as organic derivatives of water (H₂O) in which one of the hydrogen atoms has been replaced by an alkyl group, typically represented by R in organic structures. For example, in ethanol (or ethyl alcohol) the alkyl group is the ethyl group, —CH₂CH₃. Alcohols may be classified as primary, secondary, or tertiary, according to which carbon of the alkyl group is bonded to the hydroxyl group. Most alcohols are colourless liquids or solids at room temperature. Alcohols of low molecular weight are highly soluble in water; with increasing molecular weight, they become less soluble in water, and their boiling points, vapour pressures, densities, and viscosities increase. Illustrative examples of an alcohol are methanol, ethanol, butanol, octanol, propan-1-ol, propan-2-ol, 1-octen-3-ol, octane-3-ol, butan-1-ol, cetyl alcohol, acetyl alcohol, glycerol, allyl alcohol, and propargyl alcohol.

The term “optional” is intended to mean something that is not necessary or mandatory, but can be present or is available if so desired. In the present invention the term optional is associated with a drying agent which is “optionally present” which is intended to convey that the drying agent is not necessary/mandatory and can be present if so desired.

The term “absorbent material” represents a material having a capacity or tendency to absorb another substance, generally by absorption or adsorption. A spongy material absorbs water or other liquids by accommodating the liquid substance in its porous mass of interlacing fibers that forms the internal skeleton. Illustrative examples of absorbent material are cloth, sponge, fabric, paper towel, and the like.

The term “soaked” is intended to describe material that is wet due to the presence of a liquid within the pores of the material such as a fabric or a sponge. In the instant invention a fabric or sponge material can be soaked by an alcohol or a carboxylic acid or any other ingredient which may be present in the form of a liquid.

The term “container” as used herein is intended to describe any receptacle or enclosure for holding a substance, for example a carboxylic acid, alcohol, metallic base, drying agent, electrolyte, and the like. A container in the instant invention is intended to have multiple separate compartments so as to prevent the ingredients in the respective compartments from coming in contact with each other. The container in the instant invention is also intended to have a lid which is porous so as to allow the ingredients contained within it to come in contact with the air in the surroundings and also to allow passage of any gaseous substance that is generated by the evaporation of the ingredients contained within it.

The term “insect” as used herein is intended to represent pests, and ceratopogonidae, including mosquitos. The term insect includes both genders (male and female) version of the insect. The term “mosquito” or “mosquitos” represents both the male and female version of mosquitos and different varieties of mosquitos. A mosquito is any member of a group of about 3,500 species of small insects belonging to the order Diptera (flies). Within Diptera, mosquitoes constitute the family Culicidae (from the Latin Culex meaning “gnat”). The term “mosquito” also encompasses any type of mosquito (e.g., Anopheles, Aedes, Ochlerotatus, and Culex), including but not limited to Tiger mosquitoes, Aedes aborigines, Aedes Aegypti, Aedes albopictus, Aedes cantator, Aedes sierrensis, Aedes sollicitans, Aedes squamigeer, Aedes sticticus, Aedes vexans, Anopheles quadrimaculatus, Culex pipiens, Culex quinquefaxciatus, and Ochlerotatus triseriatus.

1. A composition comprising a carboxylic acid, an alcohol, a mixture of a metallic base and an electrolyte, and an optional drying agent.

2. The composition of claim 1, wherein:
(i) the carboxylic acid is selected from lactic acid, hexanoic acid, and a mixture thereof; and
(ii) the alcohol is selected from 1-octen-3-ol, ethanol, and mixtures thereof.

3. The composition of claim 2 wherein the carboxylic acid is lactic acid, and the alcohol is 1-octen-3-ol.

4. The composition of claim 2 wherein the carboxylic acid is hexanoic acid, and the alcohol is 1-octen-3-ol.

5. The composition of claim 2 wherein the carboxylic acid is a mixture of lactic acid and hexanoic acid, and the alcohol is 1-octen-3-ol.

6. The composition of claims 3, 4, or 5 wherein the metallic base is ammonium bicarbonate and the electrolyte is sodium chloride.

7. The composition of claim 6 wherein the mixture of the metallic base and electrolyte further comprises a drying agent.

8. The composition of claim 7 wherein the drying agent is selected from magnesium sulfate, silica, and drierite.

9. The composition of claims 6 or 7 wherein the composition further comprises an absorbent material soaked in the 1-octen-3-ol.

10. The composition of claim 9 wherein the absorbent material is a piece of cloth or sponge.

11. The composition of claims 2, 3, 6, 7, 8, 9, or 10 comprising from about 8% to about 40% by weight of lactic acid; from about 7% to about 20% by weight of 1-octen-3-ol; from about 35% to about 85% by weight of a metallic base; from about 1% to about 5% by weight of an electrolyte; and from about 0% to about 12% by weight of a drying agent.

12. The composition of claims 2, 3, 6, 7, 8, 9, or 10 comprising from about 8% to about 30% by weight of lactic acid; from about 7% to about 15% by weight of 1-octen-3-ol; from about 45% to about 75% by weight of the metallic base; from about 1% to about 4% by weight of the electrolyte; and from about 0% to about 10% by weight of the drying agent.

13. The composition of claims 2, 3, 6, 7, 8, 9, or 10 comprising from about 12% to about 15% by weight of lactic acid; from about 12% to about 15% by weight of 1-octen-3-ol; from about 60% to about 65% by weight of the metallic base; from about 1% to about 2% by weight of an electrolyte; and from about 0.8% to about 1.5% by weight of the drying agent.

14. A composition comprising a mixture of lactic acid and hexanoic acid, a mixture of a metallic base and an electrolyte, and an optional drying agent.

15. The composition of claim 14 wherein the metallic base is ammonium bicarbonate and the electrolyte is sodium chloride.

16. The composition of claim 14 wherein the mixture of the metallic base and electrolyte further comprises a drying agent.

17. The composition of claim 16 wherein the drying agent is selected from magnesium sulfate, silica, and drierite.

18. The composition of claim 17 wherein the drying agent is selected from magnesium sulfate, and silica.

19. The composition of claims 14, 15, 16, 17, or 18 comprising from about 33% to about 35% by weight of lactic acid; from about 13 to about 15% by weight of hexanoic acid, from about 37% to about 39% by weight of the metallic base; and from about 3% to about 4% by weight of an electrolyte.

20. The composition of claim 19 comprising from about 20% to about 30% by weight of lactic acid; from about 14 to about 15% by weight of hexanoic acid, from about 38% to about 39% by weight of the metallic base; and from about 3% to about 4% by weight of an electrolyte.

21. An insect attracting system comprising a container with at least three compartments and a breathable cover, wherein a first compartment holds a carboxylic acid, a second compartment holds an alcohol, and a third compartment holds a mixture of a metallic base and an electrolyte.

22. The insect attracting system of claim 21 wherein:
(i) the carboxylic acid is selected from lactic acid, hexanoic acid, and a mixture thereof; and
(ii) the alcohol is selected from 1-octen-3-ol, ethanol, and mixtures thereof.

23. The insect attracting system of claim 22 wherein the carboxylic acid is lactic acid, and the alcohol is 1-octen-3-ol.

24. The insect attracting system of claim 23 wherein the carboxylic acid is hexanoic acid, and the alcohol is 1-octen-3-ol.

25. The insect attracting system of claim 22 wherein the carboxylic acid is a mixture of lactic acid and hexanoic acid, and the alcohol is 1-octen-3-ol.

26. The insect attracting system of claims 22, 23, 24, or 25 wherein the metallic base is ammonium bicarbonate and the electrolyte is sodium chloride.

27. The insect attracting system of claim 26 wherein the mixture of the metallic base and electrolyte further comprises a drying agent.

28. The insect attracting system of claim 27 wherein the drying agent is selected from magnesium sulfate, silica, and drierite.

29. The insect attracting system of claims 26, 27 or 28 wherein the composition further comprises an absorbent material soaked in the 1-octen-3-ol.

30. The insect attracting system of claim 29 wherein the absorbent material is a piece of cloth or sponge.

31. The insect attracting system of claims 22, 23, 26, 27, 28, 29, or 30 comprising from about 8% to about 40% by weight of lactic acid; from about 7% to about 20% by weight of 1-octen-3-ol; from about 35% to about 85% by weight of a metallic base; from about 1% to about 5% by weight of an electrolyte; and from about 0% to about 12% by weight of a drying agent.

32. The insect attracting system of claims 22, 23, 26, 27, 28, 29, or 30 comprising from about 8% to about 30% by weight of lactic acid; from about 7% to about 15% by weight of 1-octen-3-ol; from about 45% to about 75% by weight of the metallic base; from about 1% to about 4% by weight of the electrolyte; and from about 0% to about 10% by weight of the drying agent.

33. The insect attracting system of claims 22, 23, 26, 27, 28, 29, or 30 comprising from about 12% to about 15% by weight of lactic acid; from about 12% to about 15% by weight of 1-octen-3-ol; from about 60% to about 65% by weight of the metallic base; from about 1% to about 2% by weight of an electrolyte; and from about 0.8% to about 1.5% by weight of the drying agent.

34. An insect attracting system comprising a container with at least two compartments and a breathable cover, wherein a first compartment holds a carboxylic acid, and a second compartment holds a mixture of a metallic base and an electrolyte.

35. The insect attracting system of claim 34 wherein the metallic base is ammonium bicarbonate and the electrolyte is sodium chloride.

36. The insect attracting system of claim 34 wherein the mixture of the metallic base and electrolyte further comprises a drying agent.

37. The insect attracting system of claim 36 wherein the drying agent is selected from magnesium sulfate, silica, and drierite.

38. The insect attracting system of claim 37 wherein the drying agent is selected from magnesium sulfate, and silica.

39. The insect attracting system of claims 34, 35, 36, 37, or 38 comprising from about 33% to about 35% by weight of lactic acid; from about 13 to about 15% by weight of hexanoic acid, from about 37% to about 39% by weight of the metallic base; and from about 3% to about 4% by weight of an electrolyte.

40. An insect attracting system comprising a breathable container with a breathable lid comprising a mixture of a metallic base and an electrolyte.

41. The insect attracting system of claim 40 comprising from about 2% to about 20% by weight of an electrolyte and from about 98% to about 80% by weight of a metallic base.

42. The insect attracting system of claim 41 wherein the electrolyte is selected from sodium chloride, potassium chloride, sodium carbonate, sodium bicarbonate, sodium hydroxide, and calcium chloride.

43. The insect attracting system of claim 42 comprising from about 5% to about 10% by weight of an electrolyte and from about 95% to about 90% by weight of a metallic base.

44. The insect attracting system of claim 43 further comprising a drying agent.

45. The insect attracting system of claim 44 comprising from about 0.5% to about 2% by weight of a drying agent, from about 5% to about 10% by weight an electrolyte and from about 94.5% to about 88% by weight of a metallic base.

46. The insect attracting system of claim 45 wherein the metallic base is selected from ammonium bicarbonate, sodium carbonate, and sodium bicarbonate.

47. The insect attracting system of claim 46 wherein the metallic base is ammonium bicarbonate.

48. The insect attracting system of claim 47 wherein the drying agent is selected from silica gel, magnesium sulfate, and drierite.

49. The insect attracting system of claim 48 wherein the insect is a mosquito.

50. The insect attracting system of claim 49 wherein the electrolyte is sodium chloride.

51. A method of attracting and trapping insects, wherein the method comprises:
(a) providing an insect catching device capable of holding a container;
(b) providing a composition comprising a metallic base, and an optional electrolyte;
(c) placing the composition in a container having openings within the walls of the container and/or the lid of the container, and placing said container on or inside the insect catching device;
(d) facilitating release of one or more gases from the metallic base and the optional electrolyte contained within the container;
(e) attracting the insects to the gas released from the metallic base; and
(f) utilizing the insect catching device to catch the insects attracted towards the insect catching device.

52. The method of claim 51 wherein the composition comprises from about 0% to about 20% by weight of an electrolyte and from about 100% to about 80% by weight of a metallic base.

53. The method of claim 52 wherein the composition comprises from about 2% to about 20% by weight of an electrolyte and from about 98% to about 80% by weight of a metallic base.

54. The method as claimed in claim 53, wherein the electrolyte is selected from sodium chloride and sodium bicarbonate, and the metallic base is selected from ammonium bicarbonate, sodium carbonate, and sodium bicarbonate.

55. The method as claimed in claim 54, wherein the gas is released from the composition by elevating the temperature of the composition or by vibrating the container holding the composition.

56. The method as claimed in claim 55, wherein the composition comprises a volatile solvent to help spread the gas released from the metallic base and electrolyte.

57. The method of claim 56 wherein the metallic base is ammonium bicarbonate and the electrolyte is sodium chloride.

58. The method of claim 57 wherein the composition comprises from about 5% to about 10% by weight of an electrolyte and from about 95% to about 90% by weight of the ammonium carbonate.

59. The method of claim 58 wherein the insect is a mosquito.

60. The method of claim 59 wherein the gases released from the composition is ammonia and carbon dioxide.

61. A method of attracting and trapping insects, wherein the method comprises:
(a) providing an insect catching device capable of holding a container;
(b) providing a composition comprising a carboxylic acid, an alcohol, a mixture of a metallic base and an electrolyte, and an optional drying agent;
(c) placing the composition in a container having openings within the walls of the container and/or the lid of the container, and placing said container on or inside the insect catching device;
(d) facilitating release of one or more gases from the metallic base and the optional electrolyte contained within the container;
(e) attracting the insects to the gas released from the metallic base; and
(f) utilizing the insect catching device to catch the insects attracted towards the insect catching device.

62. The method of claim 61 wherein:
(i) the carboxylic acid is selected from lactic acid, hexanoic acid, and a mixture thereof; and
(ii) the alcohol is selected from 1-octen-3-ol, ethanol, and mixtures thereof.

63. The method of claim 62 wherein the carboxylic acid is lactic acid, and the alcohol is 1-octen-3-ol.

64. The method of claim 62 wherein the carboxylic acid is hexanoic acid, and the alcohol is 1-octen-3-ol.

65. The method of claim 62 wherein the carboxylic acid is a mixture of lactic acid and hexanoic acid, and the alcohol is 1-octen-3-ol.

66. The method of claims 63, 64, or 65 wherein the metallic base is ammonium bicarbonate and the electrolyte is sodium chloride.

67. The method of claim 66 wherein the mixture of the metallic base and electrolyte further comprises a drying agent.

68. The method of claim 67 wherein the drying agent is selected from magnesium sulfate, silica, and drierite.

69. The method of claims 66 or 67 wherein the composition further comprises an absorbent material soaked in the 1-octen-3-ol, wherein the absorbent material is a piece of cloth or sponge.

70. The method of claims 62, 63, 66, 67, 68, or 69 comprising from about 8% to about 40% by weight of lactic acid; from about 7% to about 20% by weight of 1-octen-3-ol; from about 35% to about 85% by weight of a metallic base; from about 1% to about 5% by weight of an electrolyte; and from about 0% to about 12% by weight of a drying agent.

71. The method of claims 62, 63, 66, 67, 68, or 69 comprising from about 8% to about 30% by weight of lactic acid; from about 7% to about 15% by weight of 1-octen-3-ol; from about 45% to about 75% by weight of the metallic base; from about 1% to about 4% by weight of the electrolyte; and from about 0% to about 10% by weight of the drying agent.

72. The method of claims 62, 63, 66, 67, 68, or 69 comprising from about 12% to about 15% by weight of lactic acid; from about 12% to about 15% by weight of 1-octen-3-ol; from about 60% to about 65% by weight of the metallic base; from about 1% to about 2% by weight of an electrolyte; and from about 0.8% to about 1.5% by weight of the drying agent.

73. The method of claim 70, wherein the gas is released from the composition by elevating the temperature of the composition or by vibrating the container holding the composition.

74. The method of claim 71, wherein the gas is released from the composition by elevating the temperature of the composition or by vibrating the container holding the composition.

75. The method as claimed in claims 72, 73, or 74 wherein the composition comprises a volatile solvent to help spread the gas released from the metallic base and electrolyte.

76. The method of claim 76 wherein the insect is a mosquito.

77. The method of claim 76 wherein the gases released from the composition is ammonia and carbon dioxide.

78. A method of attracting and trapping insects, wherein the method comprises:
(a) providing an insect catching device capable of holding a container;
(b) providing a composition comprising a carboxylic acid, an alcohol, a mixture of a metallic base and an electrolyte, and an optional drying agent;
(c) placing the composition in a container having openings within the walls of the container and/or the lid of the container, and placing said container on or inside the insect catching device;
(d) facilitating release of one or more gases from the metallic base and the optional electrolyte contained within the container;
(e) attracting the insects to the gas released from the metallic base; and
(f) utilizing the insect catching device to catch the insects attracted towards the insect catching device.

79. The method of claim 78 wherein the composition comprises a mixture of lactic acid and hexanoic acid, a mixture of a metallic base and an electrolyte, and an optional drying agent.

80. The method of claim 79 wherein the metallic base is ammonium bicarbonate and the electrolyte is sodium chloride.

81. The method of claim 80 wherein the mixture of the metallic base and electrolyte further comprises a drying agent.

82. The method of claim 81 wherein the drying agent is selected from magnesium sulfate, silica, and drierite.

83. The method of claim 82 wherein the drying agent is selected from magnesium sulfate, and silica.

84. The method of claims 79, 80, 81, or 82 wherein the composition comprises from about 33% to about 35% by weight of lactic acid; from about 13 to about 15% by weight of hexanoic acid, from about 37% to about 39% by weight of the metallic base; and from about 3% to about 4% by weight of an electrolyte.

85. The method of claim 84 comprising from about 20% to about 30% by weight of lactic acid; from about 14 to about 15% by weight of hexanoic acid, from about 38% to about 39% by weight of the metallic base; and from about 3% to about 4% by weight of an electrolyte.

86. The method of claim 84, wherein the gas is released from the composition by elevating the temperature of the composition or by vibrating the container holding the composition.

87. The method of claim 85, wherein the gas is released from the composition by elevating the temperature of the composition or by vibrating the container holding the composition.

88. The method of claims 86 or 87 wherein the composition comprises a volatile solvent to help spread the gas released from the metallic base and electrolyte.

89. The method of claim 88 wherein the insect is a mosquito.

90. The method of claim 89 wherein the gases released from the composition is ammonia and carbon dioxide.
